(19) United States
(12) Patent Application Publication
(10) Pub. No.: US 2018/0312040 A1
(43) Pub. Date: Nov. 1, 2018

(54) RECREATIONAL VEHICLE APPLIANCE SLIDE OUT SHUTOFF CONTROLLER

(71) Applicant: Furrion Property Holding Limited, Hong Kong (HK)

(72) Inventor: Steven Neill Bell, Hong Kong (HK)

(21) Appl. No.: 15/949,685

(22) Filed: Apr. 10, 2018

Related U.S. Application Data
(60) Provisional application No. 62/491,535, filed on Apr. 28, 2017.

(51) Int. Cl. B60H 1/22

(52) U.S. Cl. CPC B60H 1/2218; B60H 2001/2231; B60H 2001/2293; B60H 2001/2246; B60H 2001/2234

(57) ABSTRACT

An assembly includes an appliance configured for use within a recreational vehicle, an electrical sensor configured to produce a slide out detection signal in response to electrical activation of a slide out control circuit of the recreational vehicle, and an automated shutoff controller in electrical communication with the electrical sensor and the appliance, the automated shutoff controller being configured to shut off at least one component of the appliance in response to receipt of the slide out detection signal from the electrical sensor.

### CROSS-REFERENCE TO RELATED APPLICATION

The present application claims the benefit of and priority to U.S. Provisional Application Ser. No. 62/491,535, filed Apr. 28, 2017, entitled RECREATIONAL VEHICLE APPLIANCE SLIDE OUT SHUTOFF CONTROLLER, which is hereby incorporated by reference in its entirety for all that it teaches and for all purposes.

### FIELD OF THE DISCLOSURE

The present disclosure relates to operation of appliances for recreational vehicle applications.

### BACKGROUND OF THE DISCLOSURE

The recreational vehicle (RV) market has been growing in recent years. Increasingly, consumers want to retain the conveniences and luxuries of home while away from it.

### SUMMARY

The present disclosure includes techniques for automatically shutting off a component of an appliance, such as a heating element of an electric fireplace, in response to activation of a slide out control circuit in a recreational vehicle.

In one example, this disclosure is directed to an assembly comprising an appliance configured for use within a recreational vehicle, an electrical sensor configured to produce a slide out detection signal in response to electrical activation of a slide out control circuit of the recreational vehicle, and an automated shutoff controller in electrical communication with the electrical sensor and the appliance, the automated shutoff controller being configured to shut off at least one component of the appliance in response to receipt of the slide out detection signal from the electrical sensor.

In another example, this disclosure is directed to a method comprising mounting an electric fireplace on an interior wall of a recreational vehicle, wherein the electric fireplace includes an electric heating element, and electrically connecting an electrical sensor to a slide out control circuit of the recreational vehicle such that the electrical sensor is operable to detect activation of the slide out control circuit and produce a detection signal in response to detecting activation of the slide out control circuit. The electrical sensor is in electrical communication with an automated shutoff controller for the electric fireplace, the automated shutoff controller being configured to shut off the electric heating element in response to receipt of the detection signal from the electrical sensor.

In a further example, this disclosure is directed to a method comprising operating an electric fireplace mounted on an interior wall of a recreational vehicle, wherein the electric fireplace includes an electric heating element, monitoring a slide out control circuit of the recreational vehicle for activation of the slide out control circuit, and, in response to activation of the slide out control circuit, shutting off the electric heating element of the electric fireplace.

### BRIEF DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 is a perspective view of an electric fireplace.

FIG. 2 is a conceptual block diagram of the electric fireplace of FIG. 1 electrically connected to a slide out control circuit for a recreational vehicle.

FIG. 3A and FIG. 3B are cut-away views of a recreational vehicle including the electric fireplace of FIG. 1 showing slide outs of the recreational vehicle in extended and collapsed positions.

FIG. 4 is a flowchart illustrating techniques for installing an electric fireplace in in a recreational vehicle.

FIG. 5 is a flowchart illustrating techniques for automatically shutting-off a heating element of an electric fireplace in response to activation of a slide out control circuit in a recreational vehicle.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrative devices and described methods and further applications of the principles of the invention which would normally occur to one skilled in the art to which the invention relates.

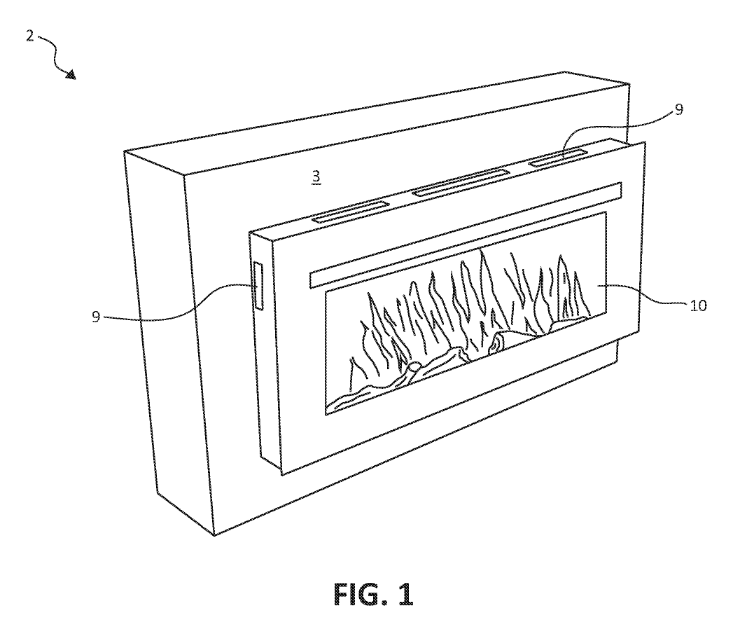

FIG. 1 is a perspective view of electric fireplace 2. Electric fireplace 2 includes a housing 3 with vents 9. A front surface of housing 3 includes an illuminated artificial flame with flame lighting 10. Electric fireplace 2 is be suitable for mounting to a wall of a recreational vehicle. For example, electric fireplace 2 may be designed for vibration resistance and/or tested for extreme climates providing increased reliability for use in a recreational vehicle compared to electric fireplaces designed for in-home use.

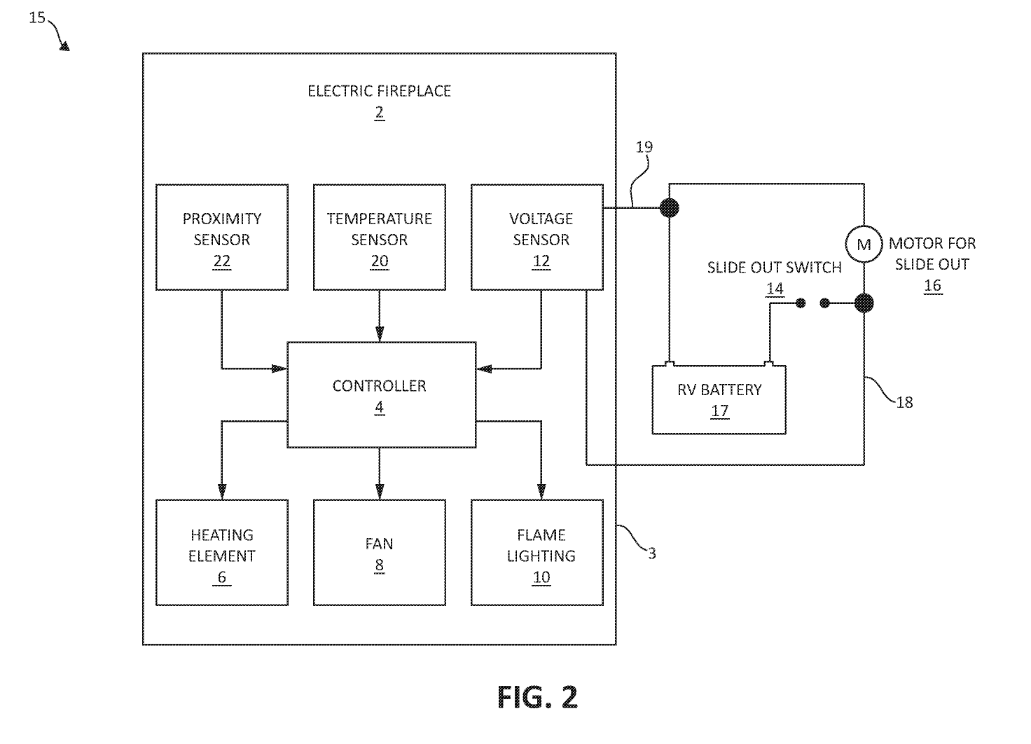

Electric fireplace 2 further includes an electric heating element 6 (FIG. 2) and an electric fan 8 (FIG. 2) configured to circulate ambient air over the electric heating element 6 via vents 9 (FIG. 1) of housing 3. The flame lighting 10 of electric fireplace 2 may include electric lighting independent of any light created by electric heating element 6. For example, flame lighting 10 may include light emitting diodes providing at least two selectable illumination levels, such as four selectable illumination levels.

Electric fireplace 2 further includes an electrical connector (not shown) for receiving power, such as an electric cord with a plug. For example, electric fireplace may be powered with an alternating current with a voltage of at least 100 volts, such as a standard alternating current of 120 volts at 60 Hertz or 230 volts at 50 hertz. In other examples, electric fireplace 2 may operate using direct current power, such as the direct current power system of a recreational vehicle, generally in the range of about 12-14.8 volts.

Although the dimensions of electric fireplace 2 are not germane to the inventions of this disclosure, in some examples, electric fireplace 2 may have a width as measured at the front surface of 30-48 inches, such as about 39.4 inches, a height as measured at the front surface of 12-24 inches, such as about 17.7 inches, and a depth, as measured perpendicular to the front surface of 3-8 inches, such as about 6.2 inches.

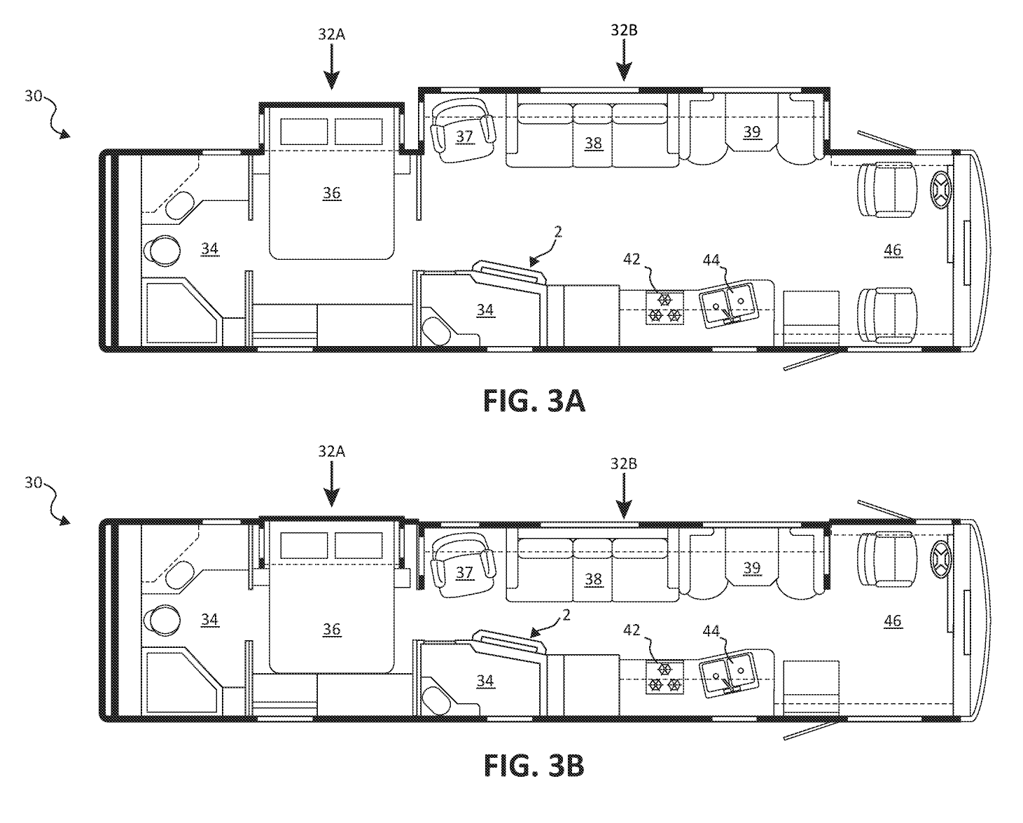

FIG. 2 is a conceptual block diagram of electric fireplace 2 connected to a slide out control circuit for a recreational vehicle, such as recreational vehicle 30 (FIG. 3A and FIG. 3B). As shown in FIG. 2, housing 3 of electric fireplace 2 encases an electric heating element 6, an electric fan 8, and flame lighting 10. Electric heating element 6 is operable to convert electricity into heat and may consume at least 500 watts of electricity during operation, such as between about 500 watts and 2500 watts. In some examples, electric heating element 6 may have at least two selectable heating levels, such as about 750 watts and about 1500 watts. Electric fan 8 is operable to circulate ambient air over the electric heating element 6 via vents 9 (FIG. 1) of housing 3 to deliver heated air within the recreational vehicle and prevent overheating of components of electric fireplace 2.

Also within housing 3 are voltage sensor 12, temperature sensor 20, and proximity sensor 22. Housing 3 further incorporates a controller 4 operable to control the operation of electric heating element 6, electric fan 8, and flame lighting 10 based on manual inputs from a user interface (not shown), such as a keypad or remote control, input from sensors 12, 20, 22, and/or based on a combination of manual inputs and inputs from sensors 12, 20, 22.

Controller 4 serves as an automated shutoff controller configured to shut off at least one component of an appliance, in this case, shutting off electric heating element 6 of electric fireplace 2. Such automatic shutoff techniques may mitigate the risk of overheating within the recreational vehicle, or provide desirable control of one or more appliances within the recreational vehicle by shutting off the appliances or components of those appliances, which may occur prior to moving the recreational vehicle or prior to stopping active use of the recreational vehicle. In the described examples, electric fireplace 2 may incorporate a variety of safety shutoff techniques provided by controller 4. In other examples, an automated shutoff controller may be a controller for another appliance, or separate from any appliance, instead serving as an external controller relative to appliances within the recreational vehicle.

As shown in FIG. 2, voltage sensor 12 is connected to slide out control circuit 15. For example, voltage sensor 12 may be within housing 3 (FIG. 1) of electric fireplace 2 and connected to slide out control circuit 15 via insulated conductors 18, 19. Slide out control circuit 15 is operable to control actuation of a slide out for a recreational vehicle, such as slide outs 32A, 32B of recreational vehicle 30 (FIG. 3A and FIG. 3B). Slide out control circuit 15 includes slide out motor 16 and slide out switch 14. Slide out switch 14 is operable to activate the slide out control circuit 15 and slide out motor 16 by connecting slide out motor 16 to a power source, such as a direct current power system of a recreational vehicle including recreational vehicle battery 17. Voltage sensor 12 is operable to detect activation of slide out control circuit 15 by monitoring voltages of slide out control circuit 15 via insulated conductors 18, 19. As shown, during activation of slide out control circuit 15 insulated conductor 18 would experience a positive voltage, such as 12 volts as compared to insulated conductor 19. In some examples, the voltages of insulated conductors 18, 19, may be reversed during activation of slide out control circuit 15, for example, if the direction of slide out motor 16 is reversed.

Controller 4, which is in electrical communication with voltage sensor 12 and electric fireplace 2 and its components, functions as an automated shutoff controller configured to shut off heating element 6 of electric fireplace 2 in response to receipt of a change in voltage from voltage sensor 12, the change in voltage representing a slide out detection signal. In some examples, the shutoff of electric heating element 6 may mitigate risk of overheating in the recreational vehicle by electric fireplace 2 due to the reduction the space inside the recreational vehicle from the collapse of the slide out. In the same or different examples, shutting off heating element 6 of electric fireplace 2 in response to receipt of a change in voltage from voltage sensor 12 may prevent overloading an electric power system of the recreational vehicle due to the electrical current required for slide out motor 16 and electric heating element 6. In the same or different examples, shutting off heating element 6 of electric fireplace 2 in response to receipt of a change in voltage from voltage sensor 12 may provide desirable operation for a user since collapsing of a slide out may occur prior to moving the recreational vehicle or prior to stopping active use of the recreational vehicle.

In some examples, controller 4 may determine whether slide out control circuit 15 is moving the slide out from an extended position to a collapsed position, or moving the slide out from a collapsed position to an extended position. Optionally, controller 4 may be configured to only shut off heating element 6 of electric fireplace 2 in response to determining slide out control circuit 15 is moving the slide out from an extended position to a collapsed position. For example, because moving a slide out from a collapsed position to an extended position would increase the space inside the recreational vehicle, it would not cause a similar risk of overheating as moving a slide out from an extended position to a collapsed position.

In different examples, other techniques may be used to detect activation of slide out control circuit 15. As one example, a different electrical sensor, such as a current sensor, may be used in place of voltage sensor 12. As another example, a mechanical switch may be used to directly detect a position of a slide out rather than activation of slide out control circuit 15. In any case, controller 4 is operable to receive a slide out detection signal representing activation of slide out control circuit 15 to facilitate shutoff at least one component of an appliance within the recreational vehicle in response to receipt of a slide out detection signal.

In the same or different examples, controller 4, which is also in electrical communication with temperature sensor 20, functions as an automated shutoff controller configured to shut off electric heating element 6 of electric fireplace 2 in response to a temperature signal from temperature sensor 20 exceeding a predetermined temperature threshold. In different examples, temperature sensor 20 may measure an internal temperature of electric fireplace 2 or an external temperature, such as an ambient air temperature. In either examples, when a predefined level or abnormal heating occurs, controller 4 may cut off the power supply to electric heating element 6 to avoid damage to electric fireplace 2 or mitigate a risk of fire. For an internal temperature, controller 4 may cut off the power supply to electric heating element 6 at a temperature between 100-200 degrees Fahrenheit, such as at about 160 degrees Fahrenheit. For an external temperature, controller 4 may cut off the power supply to electric heating element 6 at a temperature between 85-120 degrees Fahrenheit, such at about 100 degrees Fahrenheit.

In the same or different examples, controller 4 is also in electrical communication with proximity sensor 22. Proximity sensor 22 is configured to produce a proximity detection signal in response to detection of an object within a close range of an appliance, in this example, electric fireplace 2. Controller 4 also functions as an automated shutoff controller configured to shut off heating element 6 of electric fireplace 2 in response to a proximity detection signal from proximity sensor 22 indicating an object is within a predetermined distance from the proximity sensor. In different examples, controller 4 may cut off the power supply to electric heating element 6 when the proximity sensor 22 indicates an object is within about 24 inches, within about 12 inches, within about 6 inches, such as within about 4-6 inches.

In any of the above examples, in which controller 4 shuts off electric heating element 6 of electric fireplace 2, electric fan 8 may be configured to continue to circulate ambient air over electric heating element 6 after the electric heating element 6 is shut off. For example, controller 4 may continue to run electric fan 8 temporarily to facilitate cooling of electric heating element 6. In different examples, controller 4 may continue to run fan 8 for a period of about 120 seconds or less, such as a period of between about 15-120 seconds, such as a period of between about 15-60 seconds, such as a period of about 30 seconds.

FIG. 3A and FIG. 3B are cut-away views of recreational vehicle 30 with slide outs 32A, 32B and electric fireplace 2. FIG. 3A illustrates slide outs 32A, 32B in extended positions, whereas FIG. 3B illustrates slide outs 32A, 32B in collapsed positions. Recreational vehicle 30 further includes slide out control circuit 15 (FIG. 2) with slide out motor 16 (FIG. 2). Slide out control circuit 15 is operable to move slide outs 32A, 32B between the collapsed and extended positions.

Recreational vehicle 30 includes a variety of mechanical features to facilitate operation on a public roadway, such as an engine, drivetrain, brakes, exterior headlights, exterior brake lights and exterior turn signal lights. As an example, cab 46 includes a driver's seat, steering wheel and other controls to allow operation on a public roadway.

Recreational vehicle 30 also includes a number of amenities for its users including appliances and furniture. For example, recreational vehicle 30 includes bathrooms 34, bed 36, chair 37, futon sofa 38, dinette 39, refrigerator 40, stove 42, and sink 44. Recreational vehicle 30 may also include a number of appliances not shown in the figures such as, but not limited to, an oven, furnace, air conditioner, television, water heater, water pump and generator.

Slide out 32A includes bed 36, and slide out 32B includes bed 36 includes chair 37, futon sofa 38 and dinette 39. In their collapsed positions, slide outs 32A, 32B extend from an exterior wall of recreational vehicle 30. When extended, slide outs 32A, 32B maintain an enclosed space within recreational vehicle 30 in that they each contain three walls, a floor and a ceiling. The walls, floor and ceiling of each slide out 32A, 32B, seal with the stationary exterior wall of recreational vehicle 30.

The automated shutoff techniques described with respect to controller 4 and electric fireplace 2 with electric heating element 6 may also be applied to other appliances. For example, a component or all of one or more of refrigerator 40, stove 42, an oven, furnace, air conditioner, television, water heater, water pump, and/or generator may be shut off based on activation of slide out control circuit 15 as discussed with respect to electric fireplace 2.

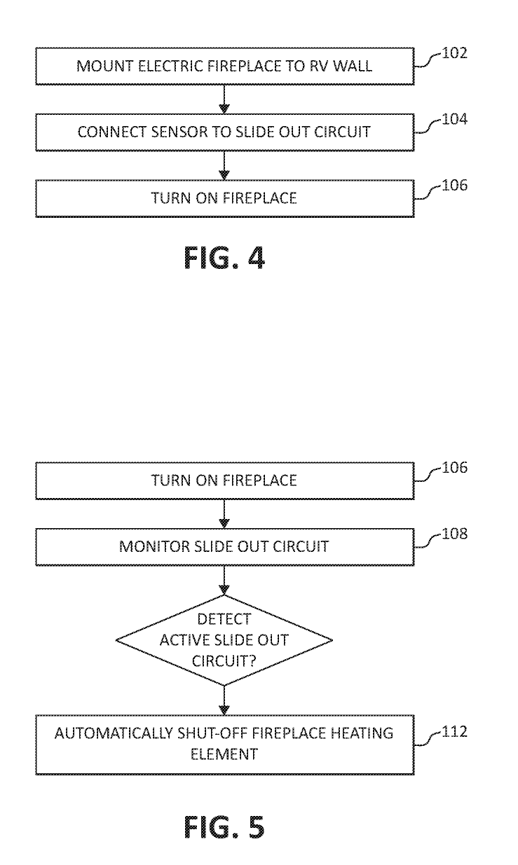

FIG. 4 is a flowchart illustrating techniques for installing an electric fireplace in in a recreational vehicle. For clarity, the techniques of FIG. 4 are described with respect to electric fireplace 2 and recreational vehicle 30. An installer mounts electric fireplace 2 on an interior wall of recreational vehicle 30 (102). As previously discussed, electric fireplace 2 includes electric heating element 6. The installer also connects electric fireplace 2 to a power source, such as an alternating current (AC) electrical power source of recreational vehicle 30. In addition, the installer electrically connects an electrical sensor, such as voltage sensor 12, to slide out control circuit 15 of recreational vehicle 30 (104). In this manner, the electrical sensor is operable to detect activation of slide out control circuit 15 and produce a detection signal in response to the activation of slide out control circuit 15.

A user may then operate electric fireplace 2 as mounted on the interior wall of recreational vehicle 30 (106).

FIG. 5 is a flowchart illustrating techniques for automatically shutting-off a heating element of an electric fireplace in response to activation of a slide out control circuit in a recreational vehicle. For clarity, the techniques of FIG. 5 are described with respect to electric fireplace 2 and recreational vehicle 30. As discussed with respect to FIG. 4, a user may operate electric fireplace 2 as mounted on the interior wall of recreational vehicle 30 (106).

As previously mentioned, an electrical sensor, such as voltage sensor 12, is in electrical communication with an automated shutoff controller for electric fireplace 2, such as controller 4. The automated shutoff controller monitors slide out control circuit 15 of recreational vehicle 30 (108). In response to receipt of the slide out detection signal from the electrical sensor (110), the automated shutoff controller is configured to shut off electric heating element 6 in response to receipt of the slide out detection signal from the electrical sensor (112). Electric fan 8 of electric fireplace 2 may be configured to continue to circulate ambient air over the electric heating element 6 after the shutoff of electric heating element 6, for example, based on control signals from controller 4.

As previously described, electric fireplace 2 may include temperature sensor 20, and the automated shutoff controller may be further configured to shut off heating element 6 in response to receipt of a temperature signal from temperature sensor 20 representing a temperature exceeding a predetermined temperature threshold.

In the same or different examples, electric fireplace 2 may further include proximity sensor 22, and the automated shutoff controller may be further configured to shut off heating element 6 in response to receipt of a proximity detection signal from proximity sensor 22 indicating the object is within a predetermined distance from the proximity sensor.

While described with respect to electric fireplace 2, the techniques of FIGS. 4 and 5 may readily by adapted for use with other appliances of recreational vehicle 30, including, but not limited to, refrigerator 40, stove 42, an oven, furnace, air conditioner, television, water heater, water pump, and/or generator.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An assembly comprising:
an appliance configured for use within a recreational vehicle;
an electrical sensor configured to produce a slide out detection signal in response to electrical activation of a slide out control circuit of the recreational vehicle; and
an automated shutoff controller in electrical communication with the electrical sensor and the appliance, the automated shutoff controller being configured to shut off at least one component of the appliance in response to receipt of the slide out detection signal from the electrical sensor.

2. The assembly of claim 1, further comprising a temperature sensor configured to monitor a temperature and produce a temperature signal representative of the monitored temperature
wherein the automated shutoff controller is in electrical communication with the temperature sensor, the automated shutoff controller being further configured to shut off the at least one component of the appliance or another component of the appliance in response to receipt of the temperature signal from the temperature sensor when the temperature signal exceeds a predetermined temperature threshold.

3. The assembly of claim 1, further comprising a proximity sensor configured to produce a proximity detection signal in response to detection of an object within a close range of the appliance,
wherein the automated shutoff controller is in electrical communication with the proximity sensor, the automated shutoff controller being further configured to shut off the at least one component of the appliance or another component of the appliance in response to receipt of the proximity detection signal from the proximity sensor when the proximity detection signal indicates the object is within a predetermined distance from the proximity sensor.

4. The assembly of claim 1, wherein the appliance is an electric fireplace.

5. The assembly of claim 4, wherein the electric fireplace includes an electric heating element, and a fan operable to circulate ambient air over the electric heating element.

6. The assembly of claim 5, wherein the at least one component includes the electric heating element, wherein the fan is configured to continue to circulate ambient air over the electric heating element after the electric heating element is shut off by the automated shutoff controller.

7. The assembly of claim 5, wherein the electric heating element is operable to consume at least 500 watts of electricity during operation of the electric fireplace.

8. The assembly of claim 4, further comprising an artificial flame including electric lighting.

9. The assembly of claim 8, wherein the electric lighting includes light emitting diodes providing at least two selectable illumination levels.

10. The assembly of claim 1, wherein the at least one component of the appliance is powered with an alternating current with a voltage of at least 100 volts.

11. The assembly of claim 1, wherein the slide out control circuit is a low voltage direct current circuit.

12. The assembly of claim 1, further comprising the recreational vehicle, the recreational vehicle including a slide out and the slide out control circuit, wherein the slide out control circuit is operable to move the slide out between collapsed and extended positions.

13. A method comprising:
mounting an electric fireplace on an interior wall of a recreational vehicle, wherein the electric fireplace includes an electric heating element; and
electrically connecting an electrical sensor to a slide out control circuit of the recreational vehicle such that the electrical sensor is operable to detect activation of the slide out control circuit and produce a detection signal in response to detecting activation of the slide out control circuit,
wherein the electrical sensor is in electrical communication with an automated shutoff controller for the electric fireplace, the automated shutoff controller being configured to shut off the electric heating element in response to receipt of the detection signal from the electrical sensor.

14. The method of claim 13, further comprising connecting the electric fireplace to an alternating current (AC) electrical power source of the recreational vehicle.

15. The method of claim 13,
wherein the electric fireplace includes a temperature sensor configured to monitor a temperature and produce a temperature signal representative of the monitored temperature, and
wherein the automated shutoff controller is in electrical communication with the temperature sensor, the automated shutoff controller being further configured to shut off the electric heating element in response to receipt of the temperature signal from the temperature sensor when the temperature signal exceeds a predetermined temperature threshold.

16. The method of claim 13,
wherein the electric fireplace includes a proximity sensor configured to produce a proximity detection signal in response to detection of an object within a close range of the electric fireplace, and
wherein the automated shutoff controller is in electrical communication with the proximity sensor, the automated shutoff controller being further configured to shut off the electric heating element in response to receipt of the proximity detection signal from the proximity sensor when the proximity detection signal indicates the object is within a predetermined distance from the proximity sensor.

17. The method of claim 13,
wherein the electric fireplace includes a fan operable to circulate ambient air over the electric heating element, and
wherein the fan is configured to continue to circulate ambient air over the electric heating element after the electric heating element is shut off by the automated shutoff controller.

18. A method comprising:
operating an electric fireplace mounted on an interior wall of a recreational vehicle, wherein the electric fireplace includes an electric heating element;
monitoring a slide out control circuit of the recreational vehicle for activation of the slide out control circuit; and
in response to activation of the slide out control circuit, shutting off the electric heating element of the electric fireplace.

19. The method of claim 18,
wherein the electric fireplace includes a fan operable to circulate ambient air over the electric heating element,
the method further comprising continuing to operate the fan after to circulate ambient air over the electric heating element after shutting off the electric heating element.

20. The method of claim 18, wherein monitoring the slide out control circuit of the recreational vehicle for activation of the slide out control circuit comprises monitoring the slide out control circuit for a change in voltage.
